(19) United States
(12) Patent Application Publication
(10) Pub. No.: US 2007/0020356 A1
(43) Pub. Date: Jan. 25, 2007

(54) Method for making bread with rice flour of chief component using bread maker

(75) Inventor: Don Hwan Choi, Yansan - City (KR)

Correspondence Address: ST. ONGE STEWARD JOHNSTON & REENS, LLC, 986 BEDFORD STREET, STAMFORD, CT, 06905-5619, US

(73) Assignee: Sungkwang Electric Heat Co. LTD.

(21) Appl. No.: 11/328,615

(22) Filed: Jan. 10, 2006

(30) Foreign Application Priority Data
Jul. 25, 2005 (KR) 10-2005-0067103
Nov. 18, 2005 (KR) 10-2005-0110533

(51) Int. Cl. A21D 2/00

(52) U.S. Cl. 426/18

(57) ABSTRACT

A method for making bread with rice flour being a chief component using a bread maker is provided. The method includes the steps of: intermittently kneading the rice flour for thirty seconds to two minutes at a temperature of 32±10° C., and generally kneading the rice flour for 15 minutes to 25 minutes at a temperature of 32±10° C.; primarily fermenting the kneaded rice flour for 3 minutes to 30 minutes at a temperature of 32±10° C. to 34±10° C., and performing gas-out for one minute to 10 minutes at a temperature of 32±10° C. to 34±10° C.; and secondarily fermenting the gas-out rice flour for thirty minutes to ninety minutes at a temperature of 32±10° C. to 34±10° C., and baking the fermented rice flour for ten minutes and fifty minutes at a temperature of 134±10° C. to 140±10° C.

### CROSS-REFERENCE TO RELATED APPLICATIONS

This application claims priority of Korean Patent Application No. 10-2005-0067103 filed on Jul. 25, 2005 and Korean Patent Application No. 10-2005-0110533 filed on Nov. 18, 2005.

### FIELD OF THE INVENTION

The present invention relates to a method for making bread using a bread maker, and more particularly, to a method for making bread only with rice flour without wheat flour.

### BACKGROUND OF THE INVENTION

As well known in the art, a bread making method is comprised of complex processes of preparing, kneading, fermenting, and baking material such as wheat flour, sugar, and baking powder. Therefore, it is very troublesome and difficult for consumers to directly make bread at a home with satisfaction.

Accordingly, a home bread maker for automatically executing steps of kneading, fermenting, and baking the material to facilitate a user to make the bread, thereby providing consumers with a completed bread, has been developed in various types until now. Such the bread maker includes a heating chamber equipped with a built-in heater, and an external control panel for controlling temperature and humidity of the heating chamber.

However, the conventional bread maker merely makes the bread by mixing wheat flour (strong flour) being the chief component with a variety of additives (sugar, salt, skimmed milk powder, butter, yeast and the like), and cannot make bread using rice flour. That is because, if the bread is made with the rice flour in the same method as that of the wheat flour, gluten is not be well formed, and the bread is less swelled, thereby not make delicious bread.

### SUMMARY OF THE INVENTION

Accordingly, the present invention is directed to a method for making bread with rice flour as a chief component using a bread maker that substantially overcomes one or more of the limitations and disadvantages of the conventional art.

One object of the present invention is to provide a method for making bread only with rice flour without wheat flour when the bread is made using a bread maker.

Another object of the present invention is to provide a method for making white or black rice bread within a short time (about two hours±20 minutes).

A further another object of the present invention is to provide a method for making bread with rice using a bread maker by controlling temperature and time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a method for making bread with rice flour as a chief component using a bread maker, the method including the steps of: intermittently kneading the rice flour for thirty seconds to two minutes at a temperature of 32±10° C., and generally kneading the rice flour for 15 minutes to 25 minutes at a temperature of 32±10° C.; primarily fermenting the kneaded rice flour for 3 minutes to 30 minutes at a temperature of 32±10° C. to 34±10° C., and performing gas-out for one minute to 10 minutes at a temperature of 32±10° C. to 34±10° C.; and secondarily fermenting the gas-out rice flour for thirty minutes to ninety minutes at a temperature of 32±10° C. to 34±10° C., and baking the fermented rice flour for ten minutes and fifty minutes at a temperature of 134±10° C. to 140±10° C.

It is to be understood that both the foregoing summary and the following detailed description of the present invention are merely exemplary and intended for explanatory purposes only.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

First of all, the present invention provides a method for making white or black rice bread with only a percentage of 100% of rice flour, not wheat flour (strong flour), as a chief component using a bread maker. A variety of additives used for making the bread are the same as those of a conventional art. This is because consumers can variously select the bread according to their tastes. In addition, the present invention uses additives such as chestnut, peanut, jujube, raisin, and pine nut.

In the present invention, it takes about two hours (about one hour and fifty eight minutes for white rice bread, and about two hours and eight minutes for black rice bread) to make rice bread using the bread maker. This remarkably reduces a time taken to make the bread in comparison with to make bread with the wheat flour, thereby allowing the consumers to have the bread within a fast time without waiting for a long time.

A method for making the bread according to the present invention includes steps of intermittent kneading, general kneading, adding of additives, primary ferment, gas-out, secondary ferment, and baking. It takes about two hours to perform the steps. A heat-retaining time is about three hours. Table 1 shows the above method for making the bread in detail.

TABLE 1

| | White | | Black | | | |
|---|---|---|---|---|---|---|
| | rice bread | | rice bread | | Mix bread | |
| Process | Time (min) | Temp. (±10° C.) | Time (min) | Temp. (° C.) | Time (min) | Temp. (±10° C.) |
| Intermittent kneading | 0.5-2 | 32 | 0.5-2 | 32 | 4 | 32 |
| Rest | | 32 | — | 32 | 6 | 32 |
| Primary kneading | 15-25 | 32 | 15-25 | — | 25 | 32 |
| Additive | — | 32 | — | 32 | — | 32 |
| Secondary kneading | — | — | — | — | 5 | 32 |
| Primary ferment | 3-30 | 32-34 | 3-30 | 32-34 | 45 | 32-34 |
| Gas out | 1-10 | 32-34 | 1-10 | 32-34 | 30 sec | 32-34 |
| Secondary ferment | 30-90 | 32-34 | 30-90 | 32-34 | 60 | 32-34 |
| Baking | 10-50 | 134-140 | 10-50 | 134-140 | 45 | 108-118 |
| Cooling | — | — | — | | | — |

| | |
|---|---|
| Heat-retaining time & | About 180 min & 56° C. |
| temperature | |

| | |
|---|---|
| Strong flour bread | Korean-grown wheat bread |

| Process | Time (min) | Temp. (±10° C.) | Time (min) | Temp. (° C.) |
|---|---|---|---|---|
| Intermittent kneading | 4 | 32 | 5 | 32 |
| Rest | 6 | 32 | 5 | 32 |
| Primary kneading | 25 | 32 | 30 | 32 |
| Additive | | 32 | — | 32 |
| Secondary kneading | 5 | 32 | 5 | 32 |
| Primary ferment | 45 | 32-34 | 50 | 32-34 |
| Gas out | 30 sec | 32-34 | 30 sec | 32-34 |
| Secondary ferment | 60 | 32-34 | 70 | 32-34 |
| Baking | 45 | 111-121 | 45 | 111-121 |
| Cooling | 10 | — | 10 | — |

| | |
|---|---|
| Heat-retaining time & | About 180 min & 56° C. |
| temperature | |

As shown in the Table 1, when the white rice bread and the black rice bread is made, the variety of additives can be selectively added according to consumers' tastes, and if the additive is added, the secondary kneading can be also performed.

Hereinafter, a preferred embodiment of the present invention will be made in detail, and does not limit a scope of the present invention.

### First Embodiment

After rice flour was input to a bread maker, it was intermittently kneaded (about thirty times) for about one minute at a temperature of 32±10° C. and then, was generally kneaded (about one hundred fifty times) for nineteen minutes at the temperature of 32±10° C. At this time, after the above kneading processes, the variety of additives can be added according to the consumers' tastes.

After that, the kneaded rice flour was primarily fermented for five minutes at a temperature of 32±10° C. to 34±10° C. and then, a gas-out (preferably, gas-out at the time of about 150 times of kneading) is performed for about three minutes at the same temperature. Next, the gas-out rice flour was secondarily fermented for sixty minutes at the temperature of 32±10° C. to 34±10° C. and then, was baked for thirty minutes at a temperature of 134±10° C. to 140±10° C., thereby making the bread. A total time required was one hour and fifty-eight minutes.

### Second Embodiment

After black rice flour was input to a bread maker, it was intermittently kneaded (thirty times) for about one minute at a temperature of 32±10° C. and then, was kneaded for about nineteen minutes at the same temperature and then, was primarily fermented for ten minutes at a temperature of 32±10° C. to 34±10° C. At this time, before the primary ferment, a variety of additives can be also added according to consumers' tastes.

After that, the bread maker was gas-out for about three minutes and then, the gas-out rice flour was also secondarily fermented for about sixty five minutes at the same temperature and then, was baked for about thirty eight minutes at the temperature of 134±10° C. to 140±10° C., thereby making the black rice bread. A total time required was two hours and eight minutes.

As described above, the present invention can set such a condition for making the bread (time and temperature), thereby making the white rice bread or the black rice bread using the bread maker, and concurrently solves a drawback of the conventional art of having no choice but to make only wheat flour bread. Particularly, the present invention has an advantage in that, when the bread is made with the rice flour, the time taken to make the bread is remarkably reduced (about two hours), thereby preventing the consumers from waiting for a long time.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A method for making bread with rice flour as a chief component using a bread maker, the method comprising the steps of:
intermittently kneading the rice flour for thirty seconds to two minutes at a temperature of 32±10° C., and generally kneading the rice flour for 15 minutes to 25 minutes at a temperature of 32±10° C.;
primarily fermenting the kneaded rice flour for 3 minutes to 30 minutes at a temperature of 32±10° C. to 34±10° C., and performing gas-out for one minute to 10 minutes at a temperature of 32±10° C. to 34±10° C.; and
secondarily fermenting the gas-out rice flour for thirty minutes to ninety minutes at a temperature of 32±10° C. to 34±10° C., and baking the fermented rice flour for ten minutes and fifty minutes at a temperature of 134±10° C. to 140±10° C.

2. The method according to claim 1, further comprising the step of inputting a variety of additives at a temperature of 32±10° C. between the general kneading and the primary fermenting.

3. The method according to claim 1, wherein a time of about two hours±twenty minutes is required to perform the method for making the bread.
